(19) United States
(12) Patent Application Publication
(10) Pub. No.: US 2006/0110505 A1
(43) Pub. Date: May 25, 2006

(54) Immersion tube antimicrobial treatment

(76) Inventor: Fritz Norbury, Carthage, MO (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(21) Appl. No.: 11/034,076

(22) Filed: Jan. 12, 2005

Related U.S. Application Data
(60) Provisional application No. 60/535,883, filed on Jan. 12, 2004.

(51) Int. Cl. A23B 4/20

(52) U.S. Cl. 426/335; 426/332

(57) ABSTRACT

A generally U-shaped treatment tube for immersing meat in an antimicrobial treatment solution is provided. The apparatus includes an inlet for receiving meat, an outlet for removing meat, a solution inlet for introducing antimicrobial treatment solution into at least a U-shaped section of a tube and a solution outlet to allow solution to be removed from or recycled back through the U-shaped section of the tube. The antimicrobial solution is preferably an alkali silicate containing solution.

### FIELD OF THE INVENTION

This invention relates to an apparatus and process for reducing microbial contamination on meat, particularly on poultry. The apparatus and process include immersing the meat in an antimicrobial solution while the meat is transported by the solution through a tube or pipe having at least a U-shaped portion.

### BACKGROUND OF THE INVENTION

Animals, such as, for example, poultry, red meat animals of all kinds, fish and crustaceans are killed and their carcasses are processed to produce food products for human consumption. Typically, the processing of such animals includes evisceration, which may contaminate the edible portion of the animal with unwanted bacteria, which may multiply depending upon the sanitary conditions employed in further processing steps. Bacterial contamination of the edible portions of the animal may cause spoilage of the edible portions and illness of consumers of the contaminated edible portions.

Several methods have been developed, with some regulated into use, to reduce the overall bacterial contamination rate of processed animal carcasses. Among these processes for poultry carcasses are co-current and counter-current chill tank systems and the addition of various processing aids to these tanks. Generally accepted methodologies utilize mechanical paddles or spirals to submerge and move the bird through the chilling bath.

While these methods provide adequate cleaning of the carcass and reduce the body temperature to prolong the product's freshness, they are not particularly effective at reducing bacterial contamination. To correct this, several modifications to the chill tank operation have been proposed and evaluated. For example, the addition of chlorine to the water supplying the chill tank has been evaluated. While some efficacy using this method was reported, concerns existed due to the potential for the formation of chlorinated organic compounds and their subsequent effect upon ingestion. Several methods, including competitive bacterial exclusion and the treatment of processed carcasses with peroxides, acids, surfactants and other compounds were also proposed. See, for example, U.S. Pat. Nos. 3,104,170; 4,683,618; and 4,770,884. Some of these methods have been eliminated due to their inherent negative effects on poultry or concern for the safety of the resulting product when ingested.

U.S. Pat. No. 4,849,237 discloses a method for sanitizing poultry carcasses in a poultry processing plant. The method involves sanitizing the bird with ozonated water after scalding, de-feathering, eviscerating and chilling the bird being treated. The application of the ozonated water to the bird involves both immersing the external portion of the bird in a bath of ozonated water and, while immersed in the bath, subjecting the bird to jets of ozonated water directed into the body cavity of the carcass and along the outside of the carcass. This method is problematic in that it requires an additional area outside of the processing plant production line to synthesize the ozone gas and dissolve it in water prior to treatment. As a result, the costs of treating the birds are significantly increased.

Treatment processes which involve contacting animal carcasses, including poultry, with aqueous solutions containing alkali metal phosphates and which are effective in reducing bacterial contamination and/or retarding bacterial growth without substantial detriment to the organoleptic properties of the carcasses have been shown to be most effective. Commonly assigned U.S. Pat. No. 5,069,922 teaches a process for treating poultry carcasses to control salmonellae growth. More specifically, this method comprises treating the poultry with a treatment solution having a pH above about 11.5 and containing a trialkali metal orthophosphate, also see commonly assigned U.S. Pat. No. 5,283,073.

To utilize the orthophosphate processes on a commercial scale, generally a long tank is fabricated to allow the plant's overhead monorails to pull the birds through bath containing the treatment solution. More recently, a spray cabinet with spray nozzles is fabricated to allow the plant's overhead monorails to pull the birds through the cabinet upside down. The cabinet sprays the birds and attempts to fill the body cavity.

Some of the known processes tend to introduce the relatively high amounts of phosphate compounds into treatment waste streams, which may be undesirable from an environmental perspective.

Accordingly, there exists a need in the art for an environmentally safe, simplified, and cost efficient method for treating poultry (or other edible animals) to significantly reduce the amounts of potentially microbial contamination while providing a method which is commercially viable on a plant scale.

### BROAD ASPECT OF THE INVENTION

In a broad aspect of the invention there is provided an antimicrobial treatment apparatus and method for reducing microbial contamination on meat, and in particular eviscerated poultry carcasses. The apparatus includes a chamber wherein meat can be immersed in an antimicrobial solution. In a highly preferred aspect, the chamber is a U-shaped portion of a tube. The chamber is typically part of an apparatus. That apparatus typically includes an inlet for receiving the meat, an outlet for removing the meat, a solution inlet for introducing antimicrobial treatment solution into the apparatus, and a solution outlet to allow solution to be removed from or recycled back through the apparatus. The inlet portions can be the same or integral or can be distinct. The outlet portions can be the same or integral or can be distinct. The chamber is typically operably connected to the inlet(s) and the outlet(s). Preferably, the chamber is directly operably connected to the meat inlet and the meat outlet. In a preferred aspect, the solution has a density very similar to that of the meat—thereby permitting the meat to flow through the chamber by flow of the solution.

The present invention will now be described with reference to the chamber being a U shaped portion of a tube. However, it is to be understood that other suitable shaped chambers would suffice.

### SUMMARY OF THE INVENTION

The invention is generally directed to an antimicrobial treatment apparatus and method for reducing microbial contamination on meat, and in particular eviscerated poultry carcasses. The apparatus includes a tube having at least a U-shaped portion for immersing a poultry carcass in an antimicrobial treatment solution. The apparatus includes an inlet for receiving the poultry carcass, an outlet for removing the poultry carcass, a solution inlet for introducing antimicrobial treatment solution into the tube, and a solution outlet to allow solution to be removed from or recycled back through the tube.

In one aspect the present invention provides a method of reducing microbial contamination of meat comprising treating said meat in an antimicrobial treatment apparatus comprising a tube having at least a U-shaped portion, wherein said meat and antimicrobial solution pass through the tube having at least a U-shaped portion such that said meat is immersed in said antimicrobial solution.

In one aspect the present invention provides an antimicrobial treatment apparatus for reducing microbial contamination on meat comprising a tube having at least a U-shaped portion for immersing said meat in an antimicrobial treatment solution.

In one aspect the present invention provides an antimicrobial treatment apparatus for reducing microbial contamination on meat comprising a tube having at least a U-shaped portion for immersing said meat in an antimicrobial treatment solution, wherein said tube is fitted with underwater spray nozzles.

In one aspect the present invention provides a meat product prepared by a method as described herein.

In one aspect the present invention provides a meat product obtainable by a method as described herein.

In a highly preferred aspect, the meat is at least substantially (preferably totally) immersed in the antimicrobial solution in the u-shaped portion of the tube.

Preferably both meat and antimicrobial solution pass through said tube having at least a U-shaped portion in the same direction. However it will be appreciated that the meat and the antimicrobial solution may pass through said tube having at least a U-shaped portion in the opposite directions.

In one preferred aspect said meat has a buoyancy substantially equal to said antimicrobial solution. In other words the meat and the said antimicrobial solution have substantially the same density.

In one preferred aspect said meat is poultry. In one preferred aspect said meat is a carcass. In one preferred aspect said meat is an eviscerated carcass. In one preferred aspect said meat is an eviscerated poultry carcass.

Preferably said antimicrobial solution comprises one or more alkali silicates. Preferably the alkali silicate(s) is selected from sodium disilicates, potassium disilicates, sodium metasilicates and mixtures thereof. More preferably the alkali silicate comprises one or more of anhydrous sodium metasilicate, anhydrous potassium metasilicate, sodium metasilicate pentahydrate, sodium metasilicate hexahydrate and sodium metasilicate nonahydrate.

The alkali silicate may be selected to have any suitable solubility. In one aspect the alkali silicate has a solubility of greater than 0.5 wt %., preferably greater than 3 wt %, in water.

The antimicrobial solution may comprise any suitable alkali silicate content. In one preferred aspect the antimicrobial solution comprises an alkali silicate content of at least 0.05 wt %, more preferably from 0.1 wt % to saturation, still more preferably from 1 to 15 wt %, and even more preferably from 5 to 10 wt %, wherein the ranges are calculated on the basis of the weight of the anhydrous alkali silicate.

Preferably the meat is immersed for at least 1 second to 5 minutes, more preferably about 5 seconds to about 2 minutes, even more preferably from about 15 seconds to about 1 minute, even more preferably from about 10 seconds to about 40 seconds and most preferably about 15 seconds.

The tube used in the apparatus and process of the present invention may be of any suitable construction to achieve the purpose of the present invention. In one aspect the tube has a diameter between 5 and 15 inches [between 12 and 38 cm], preferably about 8 inches [about 20 cm].

Preferably the tube is formed of polyvinylchloride (PVC).

### ADVANTAGES OF THE PRESENT INVENTION

Advantages of the immersion tube antimicrobial treatment according to the present invention over the prior art include:
thorough coverage of all surfaces of the treated object to insure optimum micro treatment
time exposure to the solution maximizes penetration of solution to needed micro locations (such as under the wing of a poultry carcass)
optional agitation during treatment time further increases penetration of solution to needed micro locations.

All of the above also optimize visible/physical cleaning of the treated object.

### BRIEF DESCRIPTION OF THE DRAWINGS

These and other features and advantages of the invention will be better understood from the following detailed description, which is provided in connection with the accompanying drawing.

FIG. 1 is an isometric projection of a U-shaped tube and processing apparatus according to the invention.

FIG. 2 is an isometric projection of a U-shaped tube in accordance with a second embodiment of the invention.

FIG. 3 is an isometric projection of a U-shaped tube in accordance with a third embodiment of the invention.

FIG. 4 is an isometric projection of a U-shaped tube in accordance with a fourth embodiment of the invention.

### DETAILED DESCRIPTION OF INVENTION AND PREFERRED EMBODIMENTS

In the following detailed description, reference is made to various specific embodiments in which the invention may be practiced. These embodiments are described with sufficient detail to enable those skilled in the art to practice the invention, and it is to be understood that other embodiments may be employed, and that various structural and chemical changes may be made without departing from the spirit or scope of the invention.

As used herein, the term “organoleptic” means the sensory properties, including the appearance, texture, taste and smell, of food products made from the carcass.

The bacterial contamination addressed by the method of the present invention includes pathogenic bacteria, such as, for example, salmonellae, such as Salmonella typhimurium, S. choleraesuis and S. enteriditis, as well as E. coli, camphylobacter and spoilage bacteria, such as, for example, Pseudomonus aeruginosa.

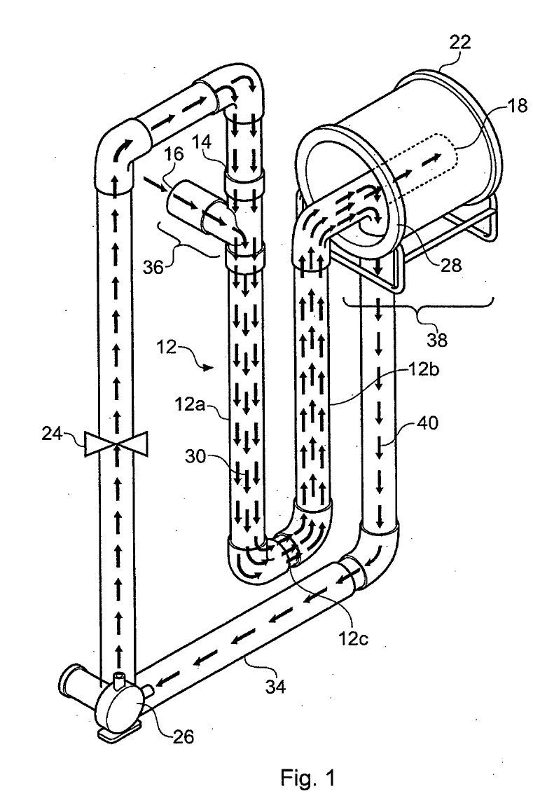

Referring to the drawings in general and to FIG. 1 in particular, an apparatus used to treat meat, preferably an eviscerated poultry carcass, with a bacteria reducing chemical solution is shown and represented by reference numeral 10. Preferably, the apparatus 10 is a station that is incorporated into an automated poultry processing system. To this end meat, preferably a poultry carcass that has been eviscerated, is conveyed to the apparatus 10 to be treated with an antimicrobial solution by immersing the meat into the solution while the meat and the solution are traveling through a U-shaped tube portion of the apparatus 10. The meat is preferably floating through the tube by way of the antimicrobial solution. The treated meat is then conveyed to the next station along the processing line for further processing.

As shown, the apparatus 10 includes a generally U-shaped treatment tube (generally represented as reference numeral 12) having a solution inlet 14 and a meat inlet 16 at an inlet side of the tube (generally represented as reference numeral 36), and a meat outlet 18 and a solution outlet 28 at an outlet side of the tube (generally represented as reference numeral 38). The U-shaped tube 12 acts to define an immersion zone filled with an antimicrobial solution as indicated by flow arrows 30.

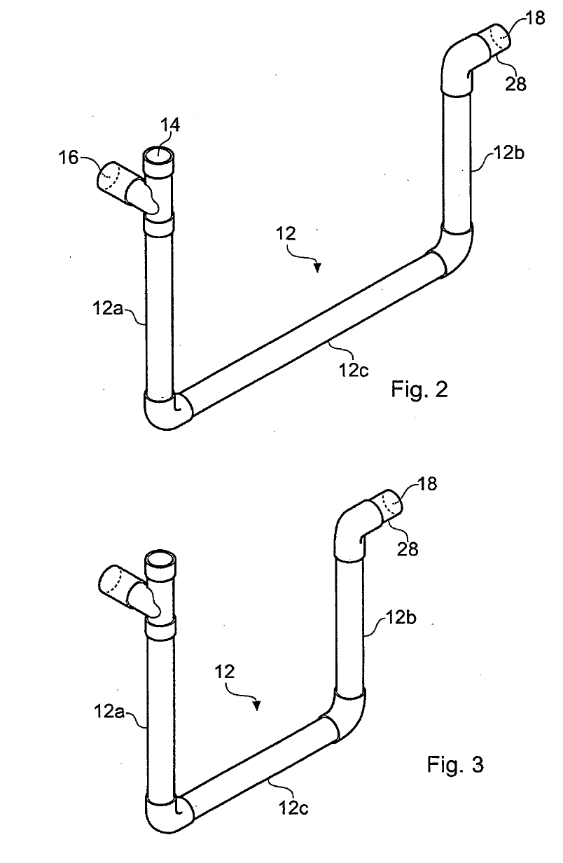

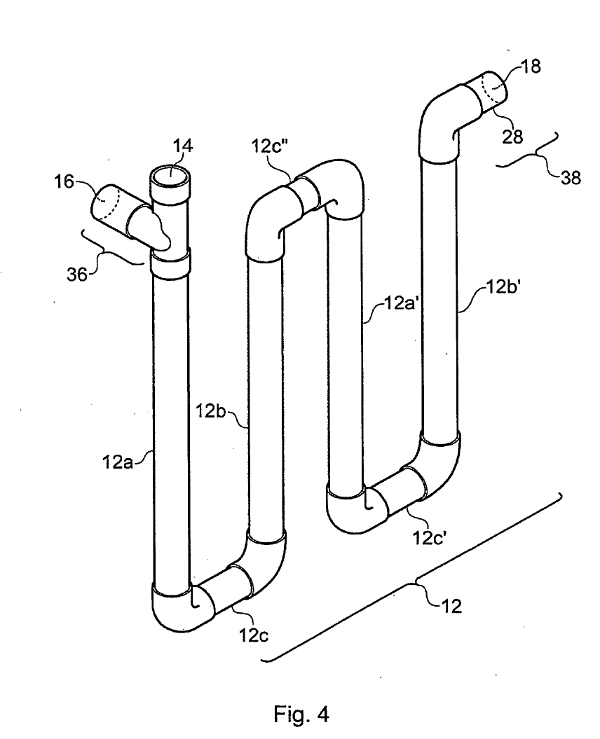

It should be noted that there may be numerous embodiments of the U-shaped treatment tube 12. As such, it should be understood that the term “U-shaped” generally describes a tube having at least two vertical pipe sections 12a, 12b in connection with a horizontal pipe section 12c. The pipe sections maybe of any suitable length. For example, vertical pipe sections 12a, 12b need not be of equivalent lengths and may be varied according to processing parameters and plant dimensions. Furthermore, the horizontal pipe section 12c need not be shorter in length than the vertical pipe sections 12a, 12b. As such, the U-shaped tube may be a semi-rectangle shape, as shown in FIG. 2, wherein the vertical pipe sections 12a, 12b are shorter than the horizontal pipe section 12c or a semi-square shape, as shown in FIG. 3, wherein the pipe sections 12a, 12b, 12c are generally equivalent. It should also be understood that the U-shaped tube 12 may also comprise one or more U-shaped tubes in connection, and may be for example W-shaped as shown in FIG. 4, having multiple vertical pipe sections 12a, 12a′, 12b, 12b′ and multiple horizontal pipe sections 12c, 12c′, 12c″.

Regardless of the configuration of the U-shaped tube 12, the diameter of the U-shaped tube is preferably any suitable diameter for receiving the meat and allowing the meat to flow or float freely through the tube 12. For treating a poultry carcass, the U-shaped tube 12 preferably, has a diameter between about 5 to about 15 inches, and is more preferably about 8 inches. However, it should be noted that the diameter and length of the U-shaped tube 12 will vary depending on the type and size of the meat to be treated and may be varied in combination with the solution flow rate to effect treatment time. The U-shaped tube 12 may also be formed of any suitable material, and is preferably formed of plastic and more preferably polyvinylchloride (PVC) plastic.

The solution inlet 14 may be any suitable opening for allowing solution to enter the U-shaped tube 12. For example, the solution inlet 14 may be an opening or a plurality of holes provided in the inlet side 36 of the tube 12. Preferably the solution inlet is located upstream of where the meat enters the tube 12. The solution outlet 28 may be any suitable outlet means for allowing solution to leave the U-shaped tube 12. The solution outlet 28 may be an opening or a plurality of holes provided in the outlet side 38. Accordingly, the meat outlet 18 and solution outlet 28 may be the same outlet. In cases where the meat outlet 18 and solution outlet 28 are not one in the same, preferably the solution outlet 28 is located upstream from the meat outlet 18 to facilitate recycling of the solution. It should also be noted that although the solution inlet 14 and meat outlet 18 are shown at the end of the U-shaped tube 12, the inlets and outlets can be positioned at sides of the tube 12.

Underwater spray nozzles “Jacuzzi Style” may be added in the side of the tube to assist in roughing up the surface of the carcass as the carcass passes through the tube. This will drive the antimicrobial treatment solution deep into the surface of the skin of the carcass.

A transporting means (not shown), for example a conveyor, may be provided at the meat outlet 18 for receiving treated carcasses from the apparatus and transporting them for further processing. The solution outlet 28 may alternatively feed into a solution recovery apparatus. In one embodiment the solution recovery apparatus is preferably a solution recovery drum 22. The solution recovery drum 22 is preferably a rotating cylinder with a plurality of parallel bars or a filter sheet which constitute the cylinder wall. The filter or the spacing of the parallel bars allows the solution to be separated from the meat, so that the solution may exit the drum and all or a portion of which may return to the system via the solution outlet 28. The solution recovery drum 22 may also be designed to include a rinsing means for rinsing the carcass prior to further processing. The drum 22 may be fabricated from any suitable material but is preferably fabricated from a synthetic material which contains no stainless steel. In yet another embodiment the solution recovery apparatus may be a gravity slide (not shown). A preferred gravity slide would include deflectors to allow the meat to bounce and roll around to provide additional solution removal.

Recovered solution, as indicated generally by reference numeral 40, from the solution outlet 28 may be returned to the solution inlet 14 or any suitable opening in the inlet side 36 of the tube 12 via a return line 34. A pump 26 may also be provided in a return line 34 for pumping recovered solution 40 from the solution outlet 28 through the return line 34 back into the tube 12 at the inlet side 36. A control valve 24 may also be provided to regulate the flow of recovered solution 40 through the return line 34.

Optionally, an agitation means (not shown) may be added to the U-shaped tube 12 for increased microbiological efficacy. The agitation means may preferably be in the form of, for example, injection nozzles placed in the sides of the tube 12. The injection nozzles may be positioned perpendicular to the movement of the solution and the meat. The agitation means may also be a spiral paddle member or a plurality of individual paddles circumferentially and axially spaced from each other (not shown) provided in the tube 12. The agitation means may be mounted on a rotatable shaft driven by a motor.

A monitor for measuring the solution level may also be provided. For example, a bubbler and/or back pressure monitor (not shown) may be provided. The monitor may facilitate the control of the level of solution supplied from the return line 34 through control valve 24 and/or the amount of solution flowing through the solution inlet 14.

In operation, an incoming meat, preferably an eviscerated poultry carcass, will be dropped into the meat inlet 16 into flowing antimicrobial solution 30. The meat will float in the antimicrobial solution through the U-shaped tube 12. It is believed that the buoyancy of the meat is near neutral in the antimicrobial solution thereby allowing the flowing solution to carry the meat through the U-shaped treatment tube 12. Accordingly the meat will be transported in the direction of flow of the solution. As the solution exits the tube 12 at the solution outlet 28, the meat will be removed from the tube 12 at the meat outlet 18. Preferably the meat outlet 18 is located in or downstream of the solution outlet 28 to facilitate the flow of the meat out of the tube 12. After leaving the tube 12, the meat may be transferred to another processing station or optionally the meat may exit the tube onto the recovery apparatus prior to being transferred to another processing station.

The solution exiting the tube 12, i.e., recovered solution 40 is pumped out of the tube and recycled to the inlet side 36 of the tube 12 through the return line 34. As discussed above a control valve 24 and/or optionally a monitor may be provided in the return line 34 between the pump 26 and the inlet side 36 to regulate the flow of recovered solution 40 from the outlet side 38 of the tube 12. The recovered treatment solution may also be filtered to remove solids prior to recycling. Preferably, the respective amounts of the one or more components of the treatment solution, as set forth below, are monitored and the composition of the solution is controlled by adding water and/or additional amounts of the metasilicate, carbonate and/or hydroxide components to the solution.

The antimicrobial solution of the invention is preferably an aqueous solution containing an effective amount of an alkali silicate to reduce bacterial contamination of the carcass and/or retard bacterial growth on the carcass as described in EP-A-1411776 herein incorporated by reference. The solution may preferably also further comprise alkali hydroxides, alkali carbonates, or combinations thereof. A preferred antimicrobial solution comprises an alkali silicate exhibiting a solubility of greater than 0.5 percent by weight (wt %) more preferably greater than 3 wt %, in water.

Compounds suitable as the alkali silicate component of the preferred antimicrobial solution are crystalline or amorphous alkali silicate compounds according to the following formula:
M₂O.m(SiO₂).nH₂O
wherein:
M is sodium or potassium,
m is a number, wherein 0.5≦m≦3.5, indicating the number of mole(s) of the SiO₂ moiety per 1 mole of M₂O moiety; and
n indicates the water content, expressed as wt % water, wherein 0%≦n≦55%.

Suitable alkali silicates include, for example, sodium disilicates, potassium disilicates, potassium metasilicates, and more preferably sodium metasilicates. The alkali silicates may be in anhydrous or hydrated form.

In a preferred solution, the alkali silicate comprises one or more metasilicates, which are crystalline products, according to M₂O.(SiO₂).n′H₂O, wherein M is Na or K and n′ is 0, 5, 6 or 9 and indicates the number of moles of water per SiO₂ moiety. In a preferred solution, the alkali silicate comprises one or more of anhydrous sodium metasilicate, anhydrous potassium metasilicate, sodium metasilicate pentahydrate, sodium metasilicate hexahydrate and sodium metasilicate nonahydrate. More preferably, the alkali silicate comprises one or more of anhydrous sodium metasilicate, anhydrous potassium metasilicate and sodium metasilicate pentahydrate. Even more preferably, the alkali silicate comprises one or more of anhydrous sodium metasilicate and anhydrous potassium metasilicate, and one or more of sodium metasilicate pentahydrate and potassium metasilicate pentahydrate.

In a preferred solution, the aqueous treatment solution comprises greater than or equal to 0.05 percent by weight (wt %) alkali silicate, more preferably from 0.1 wt % to saturation, still more preferably from 1 to 15 wt %, and even more preferably from 5 to 10 wt %, alkali silicate, wherein the ranges are calculated on the basis of the weight of the anhydrous alkali silicate.

The solution may, optionally, further comprise other components, such as for example, alkali metal salts, such as for example, NaCl, KCl, and surfactants suitable for food use.

In a preferred embodiment, the carcass is contacted with the solution in the tube for greater than or equal to about 1 second to about 5 minutes, more preferably from about 5 seconds to about 2 minutes, even more preferably from about 15 seconds to about 1 minute, even more preferably 10 seconds to 40 seconds and most preferably about 15 seconds. After treatment in the tube the solution 30 can be immediately rinsed off of the carcass or, alternatively, allowed to remain on the carcass.

Further aspects of the invention are described below:

an antimicrobial treatment apparatus for reducing microbial contamination on meat comprising a tube having at least a U-shaped portion for immersing said meat in an antimicrobial treatment solution.
preferably said meat is eviscerated poultry carcass.
preferably said tube has a diameter between 5 and 15 inches, preferably about 8 inches.
preferably said tube is formed of plastic.
preferably said tube is formed of polyvinylchloride (PVC).
preferably said tube comprises underwater spray nozzles.

The invention is particularly advantageous for various reasons. The treatment occurs within the confines of the tube, thus there is sufficient splash containment resulting in higher solution recovery. The invention does not require conventional conveyors or drip pans, resulting in lower equipment costs. The invention also minimizes the amount of floor or plant space needed as compared to conventional antimicrobial treatment processes. Microbiological results have indicated that the invention significantly reduces contamination (up to about 94%) in comparison to conventional antimicrobial treatment processes which reduce contamination by about 65%.

The invention allows simple and economical treatment of meat, particularly, poultry carcasses to reduce bacterial contamination and/or retard bacterial growth on the carcass, without substantial detriment to the organoleptic properties of the carcass and without generating a waste stream that contains a high amount of phosphates. It will be recognized by those skilled in the art that changes or modifications may be made without departing from the broad inventive concepts of the invention. It should therefore be understood that this invention is not limited to the particular embodiments described herein, but is intended to include all changes and modifications that are within the scope and spirit of the invention as set forth in the claims.

### EXAMPLE

To validate the efficacy of an immersion tube antimicrobial treatment according to the present invention for use in on line reprocessing, poultry carcasses were sampled for Aerobic Plate Count (APC), E. coli count and Salmonella incidence.

Sampling occurred for 20 test days over a 3-month period. Each day 10 incoming (control) poultry carcasses and 10 post immersion tube poultry carcasses were sampled. The antimicrobial solution used was 2% sodium metasilicate (SMS) solution for the first 9 sample days and 4% SMS thereafter. Also 5 manually reprocessed poultry carcasses were processed daily.

The sample codes used for carcasses was ‘A’ for prereprocessing treatment (control); ‘B’ for post immersion tube antimicrobial treatment and ‘C’ for post off line (manual) reprocessing.

In poultry processing some birds are fecally contaminated after evisceration. The fecal must be removed. Manual reprocessing simply takes the bird off the production line and uses a person with a knife to cut away flesh that has fecal on it. This manual procedure will lead to a loss of flesh. The appearance of the cut poultry carcasses is less appealing to the customer and the loss of the weight of the discarded flesh results in less value.

On line processing was carried out using a heavy water rinse to remove the fecal particles, then the poultry carcasses were rinsed by subjecting the carcasses with an antimicrobial sodium metasilicate solution in an immersion tube according to the present invention to kill residual pathogens. Treatment speed was approximately 140 units per minute and was constant.

Approximate time of exposure of the carcasses to the treatment solution in the immersion tube was 15 seconds.

The sampling was done by whole carcass rinse methodology:

The poultry carcass was placed into a sterile plastic bag with 400 ml of Butterfield's Buffer, the bag was closed and held in hand.

Starting at horizontal (upper arm down, forearm out horizontal at 90 degrees to upper arm) the poultry was lifted to the shoulder in a 90-110 degree arc repeatedly and quickly for 1 minute. This was done as approximately 60-90 repetitions.

Then, the outside corner of the bag was sterilized and cut open and about 100 ml solution was drained into a sterile bottle. On the B samples, which have some metasilicate residue in the 100 ml, the buffer was neutralized with diluted HCl back down to the 7-8 pH range.

The bottle was closed, placed on water ice and mailed overnight to the microbiology laboratory. The microbiology laboratory follows standard procedures.

The average data is expressed as daily averages of APC (cfu/ml and log₁₀ cfu/ml), daily averages of E. coli (cfu/ml and log₁₀ cfu/ml and percent of number of samples of less than limit of detection [>10]), and Salmonella incidence percent. Levels of significance were determined according to James L. Kenkel (1995) “Introductory Statistics for Management and Economics”, 4^{th} Edition, page 479 for aerobic plate counts and E. coli counts, page 491 (Differences of Proportions) for Salmonella data.

The results of all three months of carcass testing clearly show the effectiveness of the immersion tube antimicrobial treatment of the present invention.

Discussion

TABLE 1
Average aerobic plate counts (cfu/ml) for 10 control
(A), 10 post immersion tube (B) and 5 manual reprocessed
(C) poultry carcasses per sampling day.

| | Days 1-9 | Days 10-20 | Days 1-20 |
|---|---|---|---|
| A | 66581 | 57300 | 61477 |
| B | 4702 | 3076 | 3808 |
| C | 32456 | 30349 | 31297 |

TABLE 2
Average E. coli counts (cfu/ml), for 10 control
(A), 10 post immersion tube (B) and 5 manual reprocessed
(C) poultry carcasses per sampling day.

| | Days 1-9 | Days 10-20 | Days 1-20 |
|---|---|---|---|
| A | 1601 | 656 | 1081 |
| B | 10 | 11 | 11 |
| C | 702 | 940 | 833 |

TABLE 3
Salmonella incidence for 10 control (A), 10
post immersion tube (B) and 5 manual reprocessed
(C) poultry carcasses per sampling day.

| | Days 1-9 | Days 10-20 | Days 1-20 |
|---|---|---|---|
| A | 22% | 19% | 21% |
| B | 0 | 0 | 0 |
| C | 11% | 22% | 17% |

Salmonella Results

Table 3 demonstrates the effectiveness of the immersion tube antimicrobial treatment of the present invention in reducing Salmonella contamination. The averages of days 1 through 20 together are shown in column 3. This shows an incoming, pretreatment (A) Salmonella load of 21% on carcasses reduced to 0% post immersion tube SMS treatment (B). In contrast, manual reprocessing (C) reduced Salmonella to only 17%.

The Salmonella reduction due to immersion tube treatment with SMS is significant at the 95% level. The Salmonella reduction due to manual reprocessing is not significant at the 95% level.

The Salmonella difference between immersion tube treatment with SMS versus manual reprocessing is significant at the 95% level.

E. coli Results

Table 2 demonstrates the effectiveness of an immersion tube according to the present invention in reducing E. coli contamination. The entire twenty-day final average incoming E. coli pretreatment (A) level on carcasses of log₁₀ 3.0 cfu/ml was reduced to less than log₁₀ 1.0 cfu/ml immediately post immersion tube treatment (B), an average 2.0 log₁₀ reduction. Over the same twenty days, there were only 7% ‘less than detectable’ (i.e. >10 cfu/ml) E. coli in any incoming (A) samples, yet 92% of the post immersion tube treatment (B) samples had E. coli at less than that limit of detection (data not shown), again demonstrating the effectiveness of an immersion tube according to the present invention for use as antimicrobial treatment of carcasses.

In contrast, over the entire twenty days, the same incoming E. coli (A) of log₁₀ 3.0 was reduced by only 0.1 log₁₀ by manual reprocessing (C) having a twenty day average of log₁₀ 2.9. The manually reprocessed (C) samples had only 6% of their samples at less than the limit of detection for E. coli (data not shown).

The E. coli reduction due to immersion tube treatment with sodium metasilicate is significant at the 99% level. The E. coli reduction due to manual reprocessing is not significant at the 95% level.

The E. coli difference between immersion tube treatment with SMS versus manual reprocessing is significant at the 99% level.

APC Results

Table 1 shows the effectiveness of an immersion tube according to the present invention at reducing aerobic plate counts (APC). The entire 20 day final average on carcasses for incoming APC pretreatment (A) of log₁₀ 4.8 cfu/ml was reduced to log₁₀ 3.6 cfu/ml immediately post immersion tube treatment (B), an average reduction of 1.2 log₁₀.

In contrast, over the same twenty days, the same incoming APC (A) of log₁₀ 4.8 cfu/ml was reduced by only 0.3 log by manual reprocessing (C), having a twenty day average of log₁₀ 4.5 cfu/ml.

Overall results of the trial are quite impressive and clearly show the superiority of on line reprocessing using an immersion tube according to the present invention over manual reprocessing for the three months in the key areas of Salmonella incidence and E. coli counts.

In addition to the results above, a nearly complete elimination of visible contamination from the surfaces of the treated poultry carcasses was observed. This is thought to be due to the thorough and complete turbulent exposure to the SMS solution as the poultry is transported through the treatment process in the tube.

In summary, immersion tube antimicrobial treatment according to the present invention is an effective antimicrobial treatment for on line reprocessing.

1. A method of reducing microbial contamination of meat comprising treating said meat in antimicrobial treatment apparatus comprising a tube having at least a U-shaped portion, wherein said meat and antimicrobial solution pass through the tube having at least a U-shaped portion such that said meat is immersed in said antimicrobial solution.

2. A method according to claim 1, wherein both meat and antimicrobial solution pass through said tube having at least a U-shaped portion in the same direction.

3. A method according to claim 1 wherein said meat has a buoyancy substantially equal to said antimicrobial solution.

4. A method according to claim 1 wherein said meat is an eviscerated poultry carcass.

5. A method according to claim 1 wherein said antimicrobial solution comprises one or more alkali silicates.

6. A method according to claim 5, wherein said alkali silicate(s) is selected from sodium disilicates, potassium disilicates, sodium metasilicates and mixtures thereof.

7. A method according to claim 6, wherein said alkali silicate comprises one or more of anhydrous sodium metasilicate, anhydrous potassium metasilicate, sodium metasilicate pentahydrate, sodium metasilicate hexahydrate and sodium metasilicate nonahydrate.

8. A method according to claim 5 wherein said alkali silicate has a solubility of greater than 0.5 wt %.

9. A method according to claim 5 wherein said antimicrobial solution comprises an alkali silicate content of at least 0.05 wt % calculated on the basis of the weight of the anhydrous alkali silicate.

10. A method according to claim 1 wherein said meat is immersed for at least 1 second to 5 minutes.

11. A method according to claim 1 wherein said tube has a diameter between 5 and 15 inches.

12. A method according to claim 1 wherein said tube is formed of polyvinylchloride (PVC).

13. A meat product prepared by the method of claim 1.

14. An antimicrobial treatment apparatus for reducing microbial contamination on meat comprising a tube having at least a U-shaped portion wherein meat is located within said apparatus; wherein an antimicrobial solution is located within said apparatus; and wherein said meat is immersed in at least a portion of said antimicrobial solution.

15. An antimicrobial treatment apparatus according to claim 14 wherein said tube comprises underwater spray nozzles.

16. An antimicrobial treatment apparatus for reducing microbial contamination on meat comprising a chamber; wherein meat is located within said chamber; wherein an antimicrobial solution is located within said apparatus; wherein said meat is immersed in at least a portion of said antimicrobial solution in said chamber and flows through said chamber on flow of the solution.
